(19) United States
(12) Patent Application Publication
(10) Pub. No.: US 2008/0303179 A1
(43) Pub. Date: Dec. 11, 2008

(54) METHOD FOR MOLDING AN OPTICAL ELEMENT AND MOLDING APPARATUS THEREFOR

(75) Inventors: Shinji TANAKA, Tokyo (JP); Toshihito KAMIOKA, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: ASAHI GLASS COMPANY LIMITED, Tokyo (JP)

(21) Appl. No.: 12/120,442

(22) Filed: May 14, 2008

Related U.S. Application Data
(63) Continuation of application No. PCT/JP2006/322585, filed on Nov. 13, 2006.

(30) Foreign Application Priority Data
Nov. 14, 2005 (JP) 2005-328579

(51) Int. Cl. B29D 11/00

(52) U.S. Cl. 264/1.1; 249/111

(57) ABSTRACT

There are provided a molding method and a molding apparatus for an optical element, which are capable of heating or cooling a material in a mold with a symmetrical temperature distribution that corresponds to the shape or the optical performance of an optical element to be molded.

In a method for molding an optical element, comprises subjecting a mold to a heating step, a press-molding step and a cooling step, the mold comprising a top mold, a bottom mold and a body mold; the method comprises bringing the mold in contact with a mold stage (heat transfer member) to heat or cool in at least one of the heating step, the press-molding step and the cooling step, the heat transfer member having a substantially symmetrical temperature distribution.

### TECHNICAL FIELD

The present invention relates to a molding method and a molding apparatus for press-molding an optical element, such as a high-precision glass lens, to be used for an optical instrument.

### BACKGROUND ART

Heretofore, a molding method has been widely implemented for producing an optical element comprising a glass lens by press-molding a heated and softened glass material. Specifically, a glass material, which has been preliminarily molded into, e.g., a spherical shape, is set in a mold comprising a top mold, a bottom mold and a body mold; the glass material is softened by being heated to a temperature of about 500 to about 600° C. in a heating step; and the softened glass material is pressurized to be molded into a lens product and is cooled, followed by being taken as a final product out of the mold. Each of these steps is carried out in a chamber with a non-oxidizing atmosphere kept therein and without oxygen contained therein, to prevent oxidation of, in particular, the heated mold. The glass material in the mold is sequentially conveyed to the heating, press-molding and cooling steps arranged on a linear or a circular conveying path.

The glass lenses to be utilized in optical instruments comprise, e.g., a convex lens, a concave lens or a meniscus lens. Normally, such glass lenses are formed in a symmetrical shape and have a symmetrical characteristic in terms of optics. Recently, these lenses to be utilized in optical instruments have been required to have extremely high precision performance.

As the heat source utilized for molding a glass lens, there have been known a block heater and a tunnel heater. However, these heaters fail to have a symmetrical temperature distribution for a glass lens to be molded or do not always have the center of the peak temperature conformed to the optical axis of a glass lens to be molded. For such a reason, the temperature distribution, which is given to the glass material through the mold, is achieved as an asymmetric distribution, and a lens, which is required to be molded so as to have a symmetrical shape and characteristic, fails to be molded with sufficient precision in some cases.

When the heat source has an asymmetric temperature distribution, there has been proposed to increase the size of a mold in order to minimize the adverse effect caused by such an asymmetric temperature distribution. However, since an increase in the mold size causes an increase in heat capacity, not only a useless heat quantity is needed, but also the heating period and the cooling period increase, lowering productivity.

As the heating step and the cooling step that have been carried out, there are one carried out by contact heat transfer and one carried out by non-contact heat transfer, such as radiation heating.

As the molding method wherein heating is carried out by contact heat transfer, e.g., patent document 1 discloses, as an example, a method for bringing a mold into contact with a block having a plurality of cylindrical cartridge heaters. In a case where a glass material is softened by being heated to a temperature of about 500 to about 600° C., the glass material can be effectively heated by contact heat transfer. However, in the case of patent document 1, the heat source fails to achieve a symmetrical temperature distribution so as to be concentric with an optical element to be molded.

As the molding method utilizing a heat source making use of radiation heating, patent document 2 discloses the provision of heaters on a tunnel-shaped wall surface. Patent document 3 discloses a concentrated heating method wherein lamp heaters are disposed in a substantially annular shape around a mold. Patent document 4 discloses a molding method utilizing induction heating using a coil.

However, the heating method using radiation heating and the heating method using induction heating are poor in heat transfer efficiency. Furthermore, these heating methods are difficult to achieve a symmetrical temperature distribution. These heating methods are also difficult to align the center of a mold with the center of a heat source since the mold is heated through a space. These heating methods are expensive in terms of the device serving as the heat source, which increases the cost.

Patent document 5 discloses, as a method for heating a glass element in a symmetrical way, a heating method for utilizing a gob plate to carry out molding. However, this method cannot always heat glass in a symmetrical way, depending on, e.g., the size of a gob plate, since the heat source itself does not have a symmetrical temperature distribution. Further, this method serves as heating a gob plate for conveying a material or a molded product, neither heating a mold in a symmetrical way nor heating, in a symmetrical way, a material or a mold set in a mold. Furthermore, this method is not applicable to a molding method for conveying a material along with a mold without using a gob plate, since this method is limited to a molding method using a gob plate.

On the other hand, a method for cooling a molded product in a uniform way in a cooling step has been disclosed in, e.g., patent document 6. For example, in a case where a lens that is thicker in a central portion than the remaining portions, such as a convex lens, is molded, when the entire portions of a mold are cooled under the same condition, a thinner portion at the periphery of the lens is cooled more rapidly, producing a temperature difference between the central portion and the periphery. Since a uniform temperature distribution is achieved in the molded product, in particular, when passing the glass transition temperature, the lens is molded, having an unequal quality. Patent document 6 has the purpose of avoiding the occurrence of a uniform temperature distribution and is directed to a method for reducing the cooling speed to realize a uniform temperature distribution by making such heating control that a heater having a concentric temperature distribution is combined with heating operations at different temperatures. Although this method is a method for cooling the entire lens at a constant speed, productivity is poor since the cooling speed is reduced.

Patent document 7 discloses, as a method for producing an optical member having a refractive index distribution achieved so as to be symmetrical to the optical axis, a method for carrying out press-molding while equally cooling a mold in an annular band way from the periphery or the center of the mold. However, this method cannot always keep a desired state in the temperature distribution of the entire mold or optical element since the cooling-starting point is limited to a portion cooled in such an annular band way.

Patent document 1: JP-A-5-17170

Patent document 2: JP-B-3-55417

Patent document 3: JP-A-5-186230

Patent document 4: JP-A-63-170225

Patent document 5: JP-A-7-247126

Patent document 6: JP-A-2001-328829

Patent document 7: JP-A-2002-193627

### DISCLOSURE OF THE INVENTION

### Problems to be Solved by the Invention

The present invention is proposed, taking the above-mentioned prior art into account. It is an object of the present invention to provide a molding method and a molding apparatus for an optical element, which are capable of heating or cooling a material in a mold with a symmetrical temperature distribution that corresponds to the shape or the optical performance of an optical element to be molded.

### Means for Solving the Problems

The present invention provides a method for press-molding an optical element and a molding apparatus therefor, which are defined in the following items:

(1) A method for molding an optical element, comprises subjecting a mold to a heating step, a press-molding step and a cooling step, the mold comprising a top mold, a bottom mold and a body mold;

further comprising bringing the mold in contact with a heat transfer member to heat or cool the mold in at least one of the heating step, the press-molding step and the cooling step, the heat transfer member having a substantially symmetrical temperature distribution.

(2) The method according to item (1), wherein the temperature distribution is axisymmetrical with respect to a central axis, and wherein the central axis substantially conforms to the optical axis of the optical element to be molded by the mold.

(3) The method according to item (1), wherein the temperature distribution is point-symmetrical with respect to a central point, and wherein the central point substantially conforms to a point on the optical axis of the optical element to be molded by the mold.

(4) The method according to item (1), wherein the temperature distribution is line-symmetrical with respect to a central line, and wherein the central line substantially conforms to the central line of the optical element to be molded by the mold.

(5) The method according to item (1), wherein the temperature distribution is plane-symmetrical with respect to a central plane, and wherein the central plane substantially conforms to a central plane of the optical element to be molded by the mold.

(6) The method according to any one of items (1) to (5), wherein the mold and the heat transfer member are configured so that one of a convex portion and a concave portion engageable with the convex portion, which are formed as an engageable portion, is formed in the mold, the other is formed in the heat transfer member, and the mold and the heat transfer member are coupled together through the engageable portion, and wherein at least one of the convex portion and the concave portion of the engageable portion has a tapered guide surface formed thereon, whereby the engageable portion is put into engagement along the guide surface to perform positioning.

(7) The method according to item (6), wherein the convex portion and the concave portion have tapered guide surfaces formed thereon so as to have the same inclination as each other, and wherein the guide surfaces are engaged together, being brought into surface contact with each other.

(8) A molding apparatus for carrying out the method for molding an optical element, defined in any one of items (1) to (7), comprising a heat source for heating or cooling a mold, whereby the mold is provided with a substantially symmetrical temperature distribution by heat applied from the heat source.

(9) The molding apparatus according to item (8), further comprising a heat transfer member, the heat transfer member transferring heat from the heat source to the mold.

(10) The molding apparatus according to item (9), wherein the heat source per se forms the heat transfer member.

(11) The molding apparatus according to item (9), wherein the heat transfer member comprises a mold stage, and wherein one of the mold and the mold stage has a convex portion formed integrally therewith, and the other has a concave portion formed therein so as to be engageable with the convex portion.

(12) The molding apparatus according to item (9), wherein the heat transfer member comprises a heat transfer piece, which is interposed between the heat source and the mold stage and is separate from the heat source and the mold stage, and wherein the mold and the heat transfer piece are coupled together, being aligned with each other.

(13) The molding apparatus according to item (11) or (12), wherein the heat transfer member has a through hole formed in a central portion thereof so as to insert the heat source.

### Effects of the Invention

In accordance with the molding method according to the present invention, it is possible to heat or cool a mold in a substantially symmetrical way since the temperature distribution in the heat transfer member, which transfers heat from the heat source to the mold, is symmetric or closely symmetrical. Furthermore, since the heat transfer member is brought into contact with the mold, it is possible not only to perform heat transfer effectively but also to carry out accurate positioning easily. Accordingly, it is possible to mold, with high productivity, an optical element, which can obtain a symmetrical shape with high precision and have an optical characteristic with high precision.

In a preferred mode of the present invention, the temperature distribution is axisymmetrical with respect to a central axis, and the central axis substantially conforms to the optical axis of the optical element to be molded by the mold. Accordingly, when the optical element to be molded has an axisymmetrical shape or axisymmetrical optical characteristic, it is possible not only to improve molding precision and the optical characteristic but also to significantly improve productivity since heating or cooling can be carried out in such an axisymmetrical way in conformity with the optical element.

In another preferred embodiment of the present invention, the temperature distribution is point-symmetrical with respect to a central point, and the central point substantially conforms to a point on the optical axis of the optical element to be molded by the mold. Accordingly, when the optical element to be molded has a point-symmetric shape or point-symmetrical optical characteristic, it is possible not only to improve molding precision and the optical characteristic but also to significantly improve productivity since heating or cooling can be carried out in a point-symmetrical way in conformity with the optical element.

In another preferred embodiment of the present invention, the temperature distribution is line-symmetrical with respect to a central line, and the central line substantially conforms to the central line of the optical element to be molded by the mold. Accordingly, when the optical element to be molded has a line-symmetrical shape or line-symmetrical optical characteristic, it is possible not only to improve molding precision and the optical characteristic but also to significantly improve productivity since heating or cooling can be carried out in a line-symmetrical way in conformity with the optical element.

In another preferred embodiment of the present invention, the temperature distribution is plane-symmetrical with respect to a central plane, and the central plane substantially conforms to a central plane of the optical element to be molded by the mold. Accordingly, when the optical element to be molded has a line-symmetrical shape or line-symmetrical optical characteristic, it is possible not only to improve molding precision and the optical characteristic but also to significantly improve productivity since heating or cooling can be carried out in a plane-symmetrical way in conformity with the optical element.

In another preferred mode of the present invention, the mold can be positioned by the convex portion and the concave portion, which are engaged with each other. Accordingly, it is easy to symmetrically conform the heat transfer member to a molded product to be molded by the mold, in terms of central axis, central point, central line or central plane, and it is possible to improve the productivity of the optical element having high precision.

In accordance with the molding apparatus of the present invention, the mold and the heat transfer member can be brought into contact with each other through the entire portion of or a portion of the tapered guide surface. By this arrangement, the guide surface not only serves as easily making the centers of both members accorded to each other for positioning but also serves as the contact portion for heat transfer, increasing the contact surface area. Accordingly, it is possible to improve the efficiency of heat transfer in the heating or cooling operation, increasing productivity. In this case, when a non-contact portion (such as a slit) is partly disposed, the thermal stress caused by the difference in coefficient of thermal expansion between both members can be absorbed. Furthermore, by modifying the position or the size of the non-contact portion, it is possible to alter the amount of heat transfer or the position to change the temperature distribution.

The molding apparatus according to the present invention includes the heat source for heating or cooling a mold, and the mold is provided with a substantially symmetrical temperature distribution by heat applied from the heat source. Thus, it is possible to reliably carry out the molding method according to the present invention and to obtain a suitable effect.

In a preferred molding apparatus according to the present invention, the heat source per se forms the heat transfer member. Accordingly, it is possible to bring the heat source per se into direct contact with mold for heat transfer, improving efficiency of heat transfer.

In a preferred molding apparatus according to the present invention, a convex portion (or a recessed portion) is integrally formed at the mold stage for supporting a mold, and a recessed portion (or a convex portion), which is engageable with the convex portion (or the recessed portion) at the mold stage, is formed in the mold. Accordingly, it is possible to reliably transfer heat to the mold from the mold stage in contact with the mold and to reliably carry out symmetrically positioning, stably holding the symmetrical position during the molding process.

In a preferred molding apparatus according to the present invention, the heat transfer member comprises a heat transfer piece, which is separate from the heat source, and the heat transfer piece is incorporated into a mold. Accordingly, the mold and the heat transfer piece can be correctly prepositioned with respect to each other. In other words, it is possible to easily and correctly make a molded product and the mold aligned with each other in terms of symmetrical center during heating or cooling operation. When the shape or the characteristic of an optical element to be molded is changed, it is possible to make arbitrary adjustment so as to carry out heating or cooling in conformity with the optical element by modifying the shape of the heat transfer piece without modifying the outline of the entire mold. Accordingly, it is possible to use the same mold stage and the same heat source without changing the mold stage and the heat source, by preparing heat transfer pieces and molds having a heat transfer pieces incorporated thereinto, the heat transfer pieces having various shapes or various temperature distributions.

In a preferred molding apparatus according to the present invention, the heat source can be vertically moved through a through hole. Accordingly, by using the same heat transfer piece or the same mold stage and changing the position of the leading edge of the heat source during heating and cooling, it is possible to freely adjust the heating operation and the cooling operation in such a way that the mold is heated from a peripheral portion thereof during heating while the mold is intensively cooled at a central portion thereof during cooling, or that heating and cooling are carried out in the reverse manner, for example.

### BRIEF DESCRIPTION OF DRAWINGS

FIG. 1 is a schematic view showing the heating operation according to an embodiment of the present invention;

FIG. 2 is a graph showing a temperature distribution in the heat transfer member shown in FIG. 1;

FIG. 3 is a schematic view showing the heating operation according to a different embodiment of the present invention;

FIG. 4 is a graph showing a temperature distribution in the heat transfer member shown in FIG. 3;

FIG. 5 is a schematic view showing the heating operation according to a different embodiment of the present invention;

FIG. 6 is a schematic view showing the heating operation according to a different embodiment of the present invention;

FIG. 7 is a schematic view showing the cooling operation according to an embodiment of the present invention;

FIG. 8 is a schematic view showing the cooling operation according to a different embodiment of the present invention;

FIG. 9 is a schematic view of the engageable portion according to a different embodiment of the present invention;

FIG. 10 is a schematic view of the engageable portion according to a different embodiment of the present invention;

FIG. 11 is a schematic view of the engageable portion according to a different embodiment of the present invention;

FIG. 12 is a schematic view of the engageable portion according to a different embodiment of the present invention;

FIG. 13 is a schematic view showing an embodiment wherein the mold and the heat transfer member according to the present invention are configured as a single unit;

FIG. 14 is a schematic view showing a heat transfer piece shown in FIG. 13;

FIG. 15 is a schematic view showing another embodiment wherein the mold and the heat transfer member according to the present invention are configured as a single unit; and

FIG. 16 is a schematic view showing a different embodiment wherein the mold and the heat transfer member according to the present invention are configured as a single unit.

### EXPLANATION OF NUMERALS

2: heat source for heating,

3, 3a, 3b, 3c and 3d: mold stage,

4: heating block,

4a: heating block,

5: mold,

6: glass material,

7: heat source for cooling,

8: molded product,

9, 9a and 9b: heat transfer piece,

10: carrier,

11: spring,

12: mold stage,

20: heat source,

21 and 22: heat source for heating,

23, 24, 25, 26 and 27: auxiliary heat source for heating,

30: engageable portion,

31, 32, 34 and 35: convex portion,

33: concave portion,

39: guide surface,

51: top mold,

52: bottom mold,

53: body mold,

54: groove,

55, 55a, 55b and 55c: concave portion,

56: flange,

57: engageable portion,

58: concave portion,

59: guide surface,

71: auxiliary heat source for cooling,

91: convex portion,

92: engageable portion,

93: slit,

94: lower through hole,

95: upper through hole,

96: recessed portion.

### BEST MODE FOR CARRYING OUT THE INVENTION

The molding apparatus for molding an optical element, such as a glass lens, according to the present invention is housed in an airtight chamber. In order to prevent a mold and the like from being oxidized, the inside of the chamber is kept in a non-oxidizing atmosphere, for example, in a nitrogen atmosphere with an inert gas, such as nitrogen, filled therein. In the chamber, the mold is conveyed, and a heating step, a press-molding step and a cooling step are carried out. In the heating step, the mold is heated to such a temperature that a glass material can be softened so as to be press-molded. In the press-molding step, the heated glass material is molded into a product having certain dimensions while the glass material is continuously heated so as to prevent the temperature of the glass material from lowering, if needed. In the cooling step, the molded product is cooled to such a suitable temperature that the quality of the molded product is stabilized. The present invention is carried out in at least one of these heating, press-molding and cooling steps.

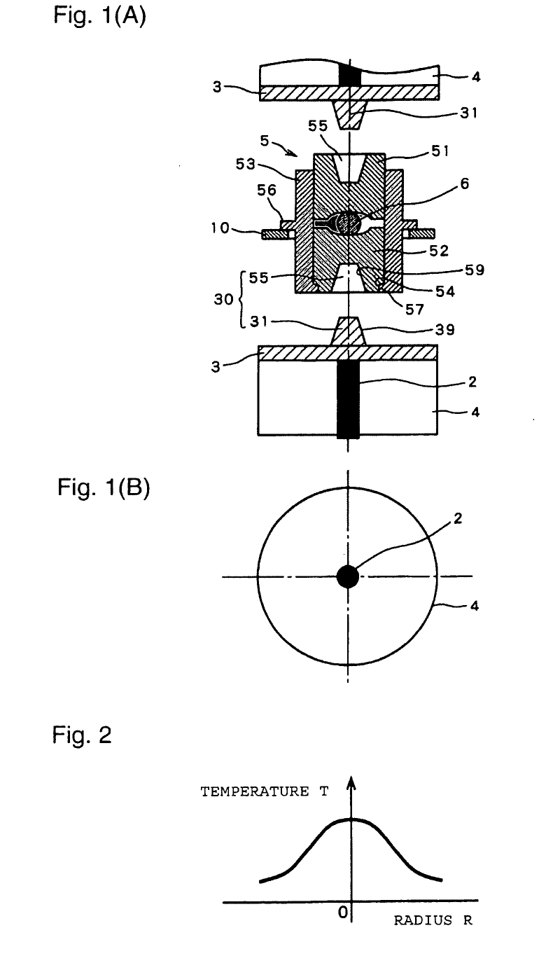

FIG. 1 shows an embodiment of the present invention, wherein an example of the heating method in the above-mentioned heating step or press-molding step is shown. FIG. 1(A) is a vertical cross-sectional view, and FIG. 1(B) is a plan view of a heating block.

The mold 5 comprises a cylindrical body mold 53, a bottom mold 52 to be fitted into the body mold 53, and a top mold 51 slidable in the body mold 53. The lower surface of the top mold 51 and the upper surface of the bottom mold 52 serve as molding surfaces, between which the material 6 is put and pressed to be molded in an optical element. The body mold 53 has a flange 56 formed on an outer periphery thereof. The body mold 53 has an engageable portion 57 formed at a lower end thereof so as to project inward. When the body mold 53 is lifted by a carrier 10, the bottom mold 52 is also lifted along with the body mold 53, being held without sliding off since the engageable portion 57 is engaged with a groove 54 formed at a lower end of the bottom mold 52. FIG. 1(A) shows a state where the mold 5 is lifted by the carrier 10.

The heating, press-molding and cooling steps are carried out in such a state that the mold 5 is sandwiched between upper and lower mold stages 3 and 3, which are brought into contact with the upper surface of the top mold 51 and the lower surface of the bottom mold 52 to receive and hold the top mold and the bottom mold.

Each of the lower surface of the bottom mold 52 and the upper surface of the top mold 51 has a recessed portion 55 formed at a central portion thereof. The respective recessed portions 55 are engaged with convex portions 31, which are formed on the respective mold stages 3 and are integral with the respective mold stages 3, the respective mold stages being brought into contact with the top and the bottom of the mold 5, respectively. The recessed portions 55 and the convex portions 31, which are engaged together, serve as engageable portions 30 between the mold 5 and the mold stages 3. In order that each recessed portion 55 can be surely engaged with its corresponding convex portion 31 even if a shift is caused during conveying the mold 5, each convex portion 31 has a tapered guide surface 39 formed so as to have larger diameters from the leading end toward the base end, whereby each convex portion is guided by its guide surface 39, being engaged with the top mold 51 and the bottom mold 52. Each recessed portion 55 also has a tapered guide surface 59 formed so as to have the same inclination as its corresponding convex portion 31. Thus, the top mold 51 and the bottom mold 52 can be correctly positioned, being aligned with the mold stages 3. When the convex portions 31 are engaged with the recessed portions 55 to bring the guide surfaces 39 and 59 into contact with each other, heat from heat sources 2 is transmitted to the inner portions of the top mold 51 and the bottom mold 52 through the guide surfaces 39 and 59. It should be noted that one of a pair of convex portion 31 and recessed portion 55 may have such a tapered guide surface formed thereon.

Cylindrical heating blocks 4 are disposed above and under the upper and lower mold stages 3. The heat sources for heating 2, each of which comprises a cartridge heaters having a circular section as shown in FIG. 1(B), are disposed at the center in the respective heating blocks 4. In this case, each heat source 2 is symmetrical with respect to the central axis of its corresponding cylindrical heating block 4, and the central axis of each heat source 2 substantially accords with the central axis of the mold 5.

In this embodiment, the heat from the heat sources 2 is transmitted to the mold 5 through the mold stages 3 with the convex portion 31 integrally formed thereon, and an axisymmetrical temperature distribution is achieved in the mold 5. In other words, in this embodiment, the mold stages 3 and the convex portions 31 integral therewith form the heat-transfer member according to the present invention.

FIG. 2 shows a temperature distribution, which is achieved in each of the mold stages 3 when the heat sources 2 shown in FIG. 1 are used. Each of the mold stages 3, which receive heat from the heat sources 2, has a temperature distribution, which is axisymmetrical with respect to the central axis of the mold 5 or is closely axisymmetrical with respect to the central axis of the mold. As a result, the material 6 is heated in an axisymmetrical way with respect to the central axis of a molded product to be molded by the mold 5. Each of the mold stages has a high temperature at a central portion thereof close to the corresponding heat source 2, and the temperature in each of the mold stages gently lowers toward the periphery. For example, when a convex lens is molded, the lens is required to be thick at a central portion thereof and thin at an edge portion thereof. By carrying out a heating method where the central portion is at a high temperature as stated, the temperature differences in the material 6 are minimized, and the material is uniformly heated.

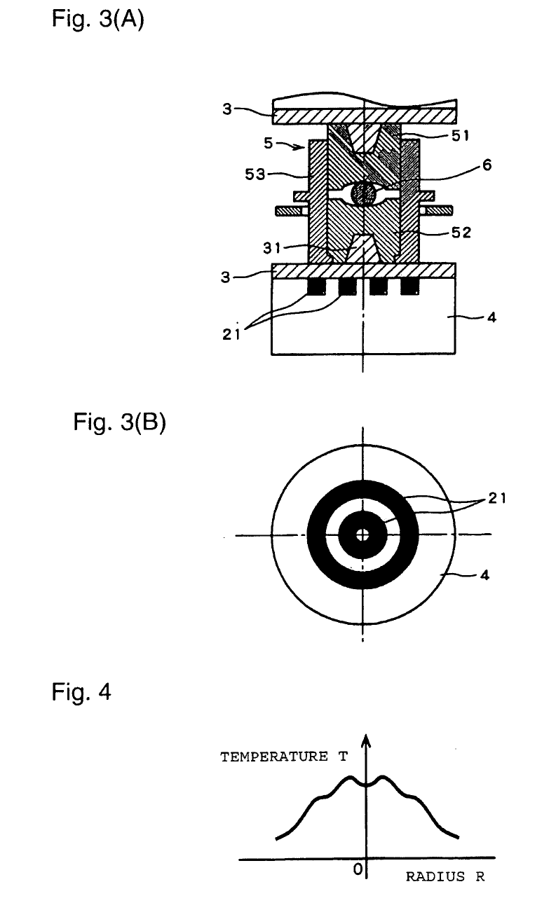

FIG. 3 shows the heating operation according to a different embodiment of the present invention. FIG. 3(A) is a vertical cross-sectional view, and FIG. 3(B) is a plan view of a heating block.

The mold 5, the mold stages 3 and the cylindrical heating blocks 4 are configured in the same way as the embodiment shown in FIG. 1. As shown in FIG. 3(B), a heat source for heating 21, which comprises an annular heater, is concentrically disposed on each of the heating blocks. In this case as well, each heat source 21 is axisymmetrical with respect to the central axis of the mold 5. Although it is normal that the heating means are disposed in the same way as each other on both upper and lower sides of the mold 5, the heat source 21 of the upper mold stage 3 is not shown in FIG. 3. In the figures showing the embodiments described below, the upper heat source is omitted.

FIG. 4 shows a temperature distribution of a mold stage 3, which is achieved when the heat sources 21 shown in FIG. 3 are used. Each of the mold stages 3, which receive heat from the heat sources 21, has a temperature distribution, which is axisymmetrical with respect to the central axis of the mold 5 or is closely axisymmetrical with respect to the central axis. As a result, the material 6 is heated in an axisymmetrical way with respect to the central axis of a product molded by the mold 5. In this case, each of the mold stages has high temperatures at the positions with the heat sources 21 disposed and has a slightly lower temperature at a central portion. The temperature distribution, which is achieved based on the size or the location of the heat sources 21, may be properly set in accordance with the shape or the characteristics of a lens to be molded. Such heat sources 21 are preferably used when it is difficult to heat the entire mold 5 only by the heat sources 2 disposed at the center as shown in FIG. 1 since the mold 5 has a large size.

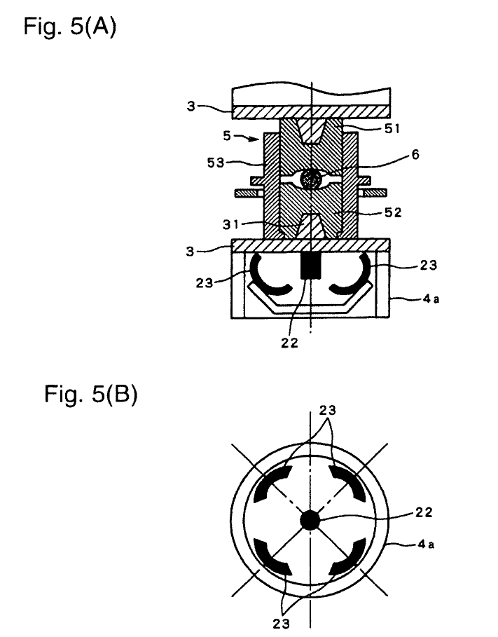

FIG. 5 shows the heating operation according to a different embodiment of the present invention. FIG. 5(A) is a vertical cross-sectional view, and FIG. 5(B) is a plan view of a heating block. The mold 5 and the mold stages 3 are configured in the same way as the embodiment shown in FIG. 1.

In each cylindrical heating block 4a having a hollow space, a heat source for heating 22, which comprises a cartridge heater having a circular cross-section, is disposed at the center of the heating block and is surrounded by auxiliary heat sources for heating 23. Each of the auxiliary heat sources 23 comprises, e.g., a halogen lamp and a heat reflector. The auxiliary heat sources are provided so as to be symmetrical with respect to the central heat source 22. In this case, as shown in FIG. 5(B), the entire heat source assembly is configured so as not only to be point-symmetrical with respect to the central axis but also to be axisymmetrical or plane-symmetrical with respect to the central axis of an auxiliary heat source 23 indicated by a dash dotted line. Accordingly, the material 6 is heated in a symmetrical way with respect to the center, the center line or a center plane (the plane passing through the central line) of a product to be molded by the mold 5.

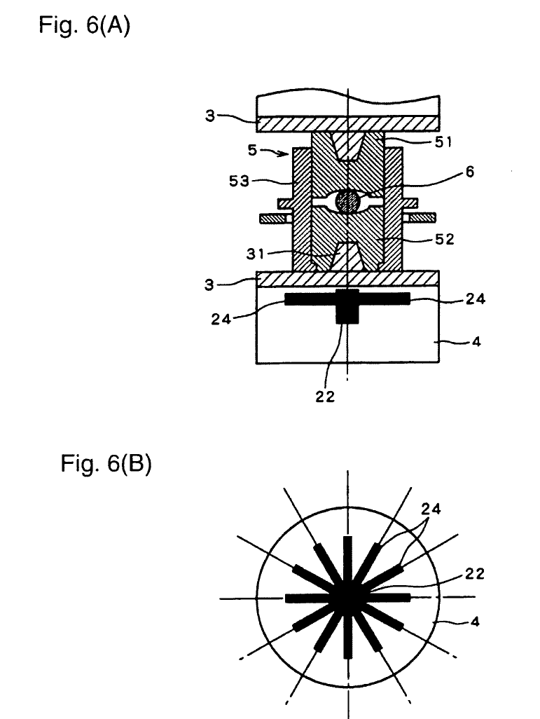

FIG. 6 shows the heating operation according to a different embodiment of the present invention. FIG. 6(A) is a vertical cross-sectional view, and FIG. 6(B) is a plan view of a heating block. The mold 5, the mold stages 3 and the cylindrical heating blocks 4 are configured in the same way as the embodiment shown in FIG. 1.

Auxiliary heat sources for heating 24, each of which comprises a bar-shaped cartridge heater, are radially disposed around a central heat source for heating 22. In this case as well, as shown in FIG. 5(B), the entire heat source assembly is configured so as not only to be point-symmetrical with respect to the central axis but also to be axisymmetrical or plane-symmetrical with respect to the central axis of an auxiliary heat source 24 indicated by a dash dotted line.

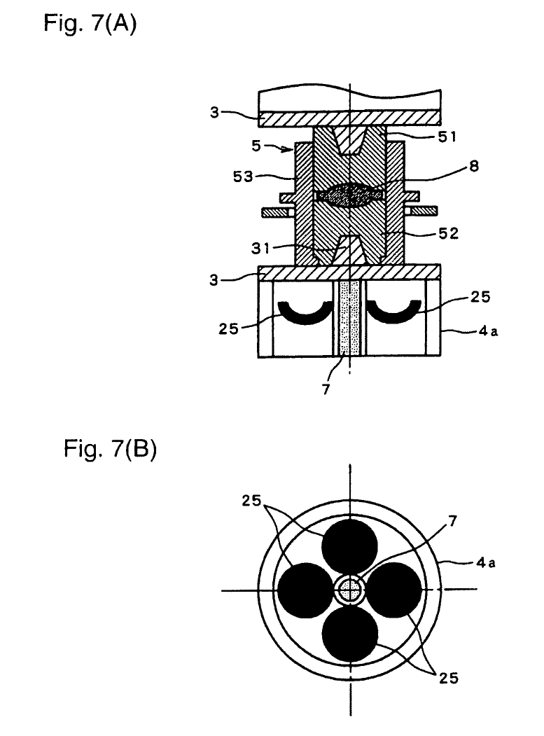

FIG. 7 shows a different embodiment of the present invention, wherein a cooling method in the cooling step is shown. FIG. 7(A) is a vertical cross-sectional view, and FIG. 7(B) is a plan view of a heating block. The mold 5 and the mold stages 3 are configured in the same way as the embodiment shown in FIG. 1.

In general, a molded product is required to be cooled with the temperature differences in the molded product minimized, since the optical element fails to have a uniform quality when a temperature difference is produced at a portion in the molded product during passing the glass transition temperature. For example, in a case where the molded product is a convex lens, when the entire molded product is cooled under the same condition, the end portion of the molded product is cooled earlier than the remaining portions since the convex lens is thick at a central portion thereof and thin at an end portion thereof. From this point of view, it is effective to adopt a method wherein in the cylindrical heating block 4a having a hollow space, a heat source for cooling 7, which comprises a cooling tube, is disposed at the center of the heating block and is surrounded by auxiliary heat sources for heating 25, which are similar to the auxiliary heat sources 23 used in the embodiment shown in FIG. 5 as shown in FIG. 7(A) so that the entire molded product 8 is cooled with the end portion thereof being kept warm. In other words, the entire molded product 8 can be uniformly cooled by intensively cooling a thick central portion of the molded product 8 and slowly cooling the thin end portion of the molded product. The heat source for cooling 7 is cooled by passing a cooling medium through the cooling tube. In this case, as shown in FIG. 7(B), the entire heat source assembly is configured so as not only to be point-symmetrical with respect to the central axis but also to be axisymmetrical or plane-symmetrical with respect to the central axis of an auxiliary heat source 25 indicated by a dash dotted line.

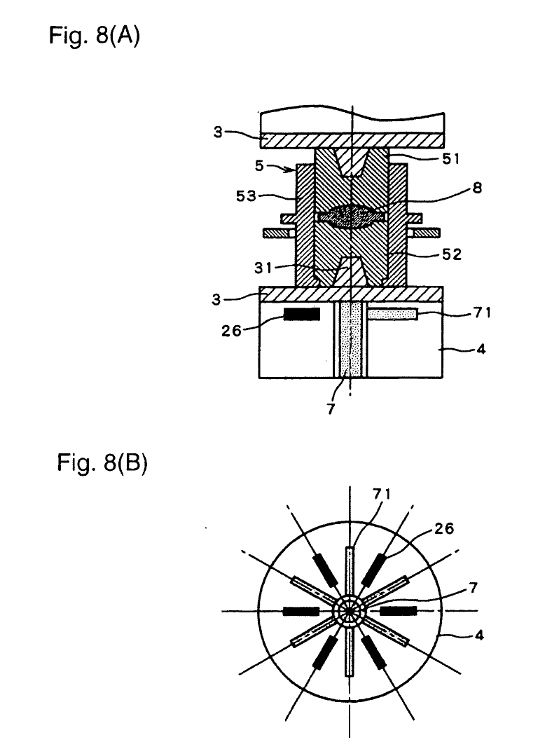

FIG. 8 shows the cooling operation according to a different embodiment of the present invention. FIG. 8(A) is a vertical cross-sectional view, and FIG. 8(B) is a plan view of a heating block. The mold 5, the mold stages 3 and the cylindrical heating blocks 4 are configured in the same way as the embodiment shown in FIG. 1.

In each of the cylindrical heating block 4, a heat source for cooling 7 is disposed at the center of the heating block and is surrounded by auxiliary heat sources for cooling 71 and auxiliary heat sources for heating 26, which are alternately and radially disposed. In this case as well, the auxiliary heat sources for heating 26 are used in order to intensively cool a central portion of the molded product 8 and to slowly cool the end portion of the molded product as in the embodiment shown in FIG. 7. In order to prevent the central portion of the molded product 8 from being heated, the heat sources for heating 26 are disposed at positions slightly away from the center. This method is preferably used when it is difficult to rapidly cool the mold 5 only by the heat source for cooling 7 disposed at the center as shown in FIG. 7 since the mold has a large size. In this case as well, as shown in FIG. 8(B), the entire heat source assembly is configured so as not only to be point-symmetrical with respect to the central axis but also to be axisymmetrical or plane-symmetrical with respect to the central axis of an auxiliary heat source for heating 26 or an auxiliary heat source for cooling 71 indicated by a dash dotted line.

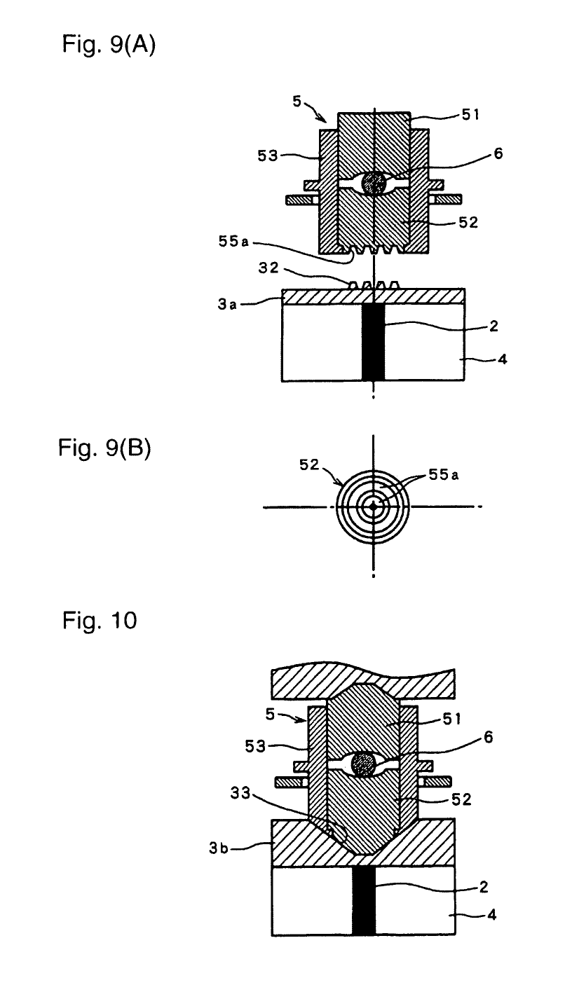

FIG. 9 and FIG. 10 are vertical cross-sectional views showing different embodiments according to the present invention, wherein the engageable portion between a mold stage and the mold 5 is formed in a different shape from the above-mentioned embodiments in each of each figures.

FIG. 9 shows the recessed portion 55a according to a different embodiment, which has tapered guide surfaces formed at each of the top mold 51 and the bottom mold 52. FIG. 9(A) is a vertical cross-sectional view, and FIG. 9(B) is a bottom view of the bottom mold 52. The recessed portion 55a comprises recessed portions annularly disposed at plural positions (two positions in this case) so as to be axisymmetrical and concentric with respect to the central axis. Each mold stage 3a has a convex portion 32 formed thereon in a similar way to the annularly disposed recessed portions. By this arrangement, for example, even when the mold 5 has a small size in the vertical direction, it is possible to ensure a sufficient contact area between the mold 5 and the mold stage 3a.

In this case as well, the mold stage 3 and the convex portion 32 integral therewith form the heat transfer member as in the above-mentioned embodiments shown in FIGS. 1 to 8.

FIG. 10 shows an embodiment wherein each mold stage 3b has a recessed portion 33 formed thereon so as to have a tapered guide surface for guiding the mold 5. The mold 5 is formed, as a whole, in such a convex shape that each of the top mold 51 and the bottom mold 52 is thick at a central portion thereof and thin at an end portion thereof so as to be engageable with each recessed portion 33. By this arrangement, an end portion of the glass material 6 is intensively heated or cooled since the end portion is brought close to the mold stages. The temperature distribution varies according to the inclination or the depth of the taper. This embodiment is particularly effective when molding an optical element having a central portion formed so as to be thicker than an end portion, such as a concave lens.

In this embodiment, the mold stages 3b form the heat transfer member.

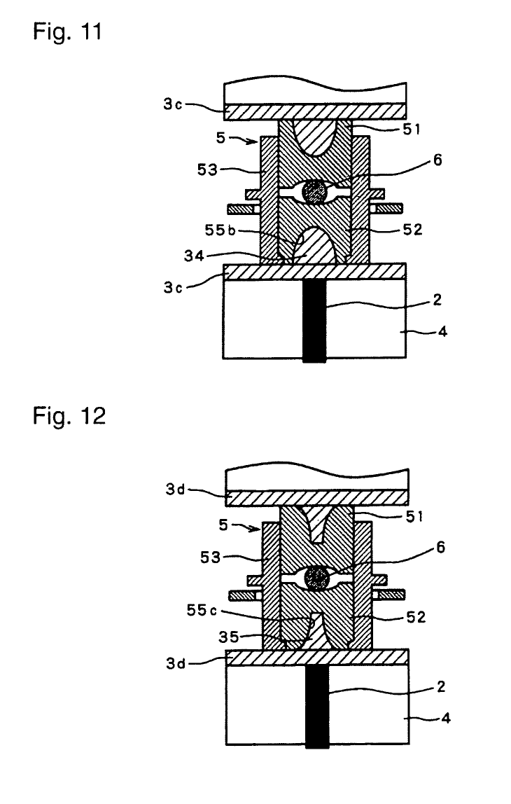

FIG. 11 and FIG. 12 are vertical cross-sectional views showing different embodiments of the present invention, wherein the engageable portion between a mold stage and the mold 5 is formed in a different shape from the above-mentioned embodiments in each of both figures.

In each of the embodiments, the guide surfaces of the recessed portion 55b or 55c of the mold 5 and the convex portion 34 or 35 of a mold stage 3c or 3d are formed in a curved shape. In the embodiment shown in FIG. 11, the material 6 is intensively heated or cooled in a wide range from a central portion to a lateral portion thereof. In the embodiment shown in FIG. 12, the material 6 is intensively heated or cooled only in a narrow central portion thereof and is slowly heated or cooled in a peripheral portion thereof. It is possible to obtain a desired heat transfer state by modifying the curvature according to the shape of an optical element to be molded.

In each of these embodiments as well, the mold stage 3c or 3d and the convex portion 34 or 35 integral therewith form the heat transfer member as in the embodiments shown in FIG. 1 to FIG. 8.

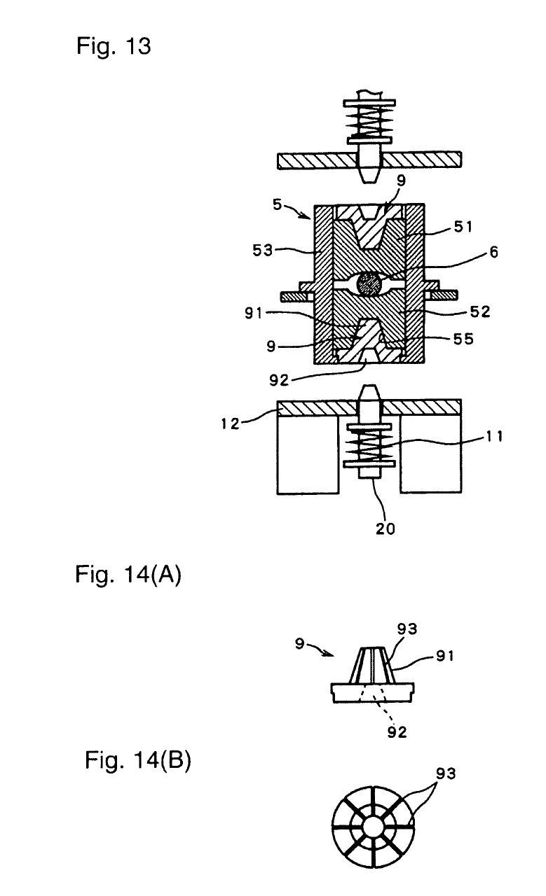

FIG. 13 is a vertical cross-sectional view showing a different embodiment of the present invention, wherein heat transfer pieces as intermediate members are interposed between mold stages and a mold so that the heat transfer pieces and the mold are configured as a single unit.

Each of the heat transfer pieces 9, which are formed as parts separate from the mold stages 12, has an engageable portion 92 formed in a base end thereof so as to be capable of receiving the leading end of the corresponding heat source 20, such as a heater or a cooling tube. Each of the heat transfer pieces has a convex portion 91 formed in a leading end thereof so as to be engageable with a recessed portion 55 formed in a top mold 51 or a bottom mold 52. Each of the heat transfer pieces 9 forms an integral part of the mold 5, being engaged with the mold. When the mold 5 is conveyed, the heat transfer pieces are conveyed along with the mold 5.

Each of the heat transfer pieces 9 is made of a material having a high thermal conductivity, such as copper. Since the material of the heat transfer pieces is different from the material of the mold 5 made of, e.g., cemented carbide, the heat transfer pieces and the mold have different coefficients of thermal expansion. For this reason, the thermal shrinkage caused by heating or cooling makes a difference in dimension, shifting the heat transfer pieces 9 vertically, in some cases. In order that the leading end of each of the heat sources 20 can be surely engaged with the corresponding heat transfer piece 9 in such a case as well, a spring 11 is disposed on the side of each of heat sources 20.

In the embodiment shown in FIG. 13, the material 6 is intensively heated or cooled in a central portion thereof since the convex portions 91 of the heat transfer pieces 9 are engaged with central portions of the top mold 51 and the bottom mold 52. By adjusting the thickness or the taper angle of the heat transfer pieces 9, it is possible to obtain a suitable heated or cooled state so as to correspond to the difference in thickness between a central portion and an end portion of an optical element to be molded in the mold 5.

In this embodiment, the heat transfer pieces 9, which are formed separately from the mold stages 12, form the heat transfer member.

FIG. 14 shows an example of the heat transfer pieces 9 used in the embodiment shown in FIG. 13. FIG. 14(A) is a front view, and FIG. 14(B) is a plan view.

In order that the mold 5 and the heat transfer pieces 9 can be kept in correct engagement with one another even when a difference in dimension is caused by the difference in coefficient of thermal expansion between the heat transfer pieces 9 and the mold 5, the heat transfer pieces 9 have plural slits 93 radially formed thereon. By this arrangement, the difference in dimension can be absorbed so that the convex portions 91 of the heat transfer pieces 9 are fitted to the recessed portions 55 of the mold 5 in terms of dimension, and the heat transfer pieces and the mold can be correctly engaged with one another. When such heat transfer pieces 9 are used, the springs 11 disposed on the heat sources 20 as shown in FIG. 13 may be omitted.

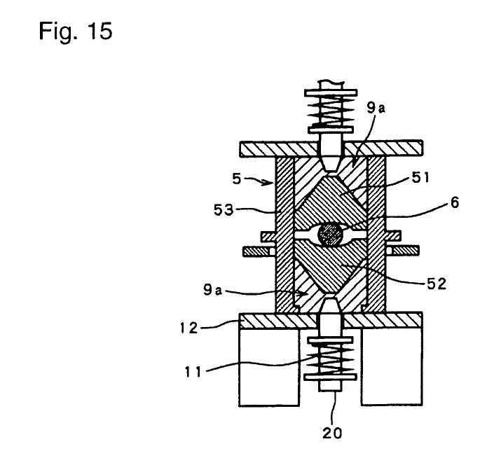

FIG. 15 is a vertical cross-sectional view showing a different embodiment of the present invention, wherein heat transfer pieces 9a and the mold 5 are configured as a single unit. This embodiment is different from the embodiment shown in FIG. 13 in that the taper of each of the heat transfer pieces has an opposite inclination.

In this embodiment, the material 6 is more intensively heated or cooled in an end portion thereof than a central portion thereof since the end portion is closer to the heat transfer pieces 9a. By modifying the shape or the material of the heat transfer pieces to adjust how to transfer heat to portions of the mold as stated above, the heat transfer pieces can be adapted for molding various shapes of optical elements.

In this embodiment as well, the heat transfer pieces 9a form the heat transfer member referred to in Claims as in the embodiment shown in FIG. 13.

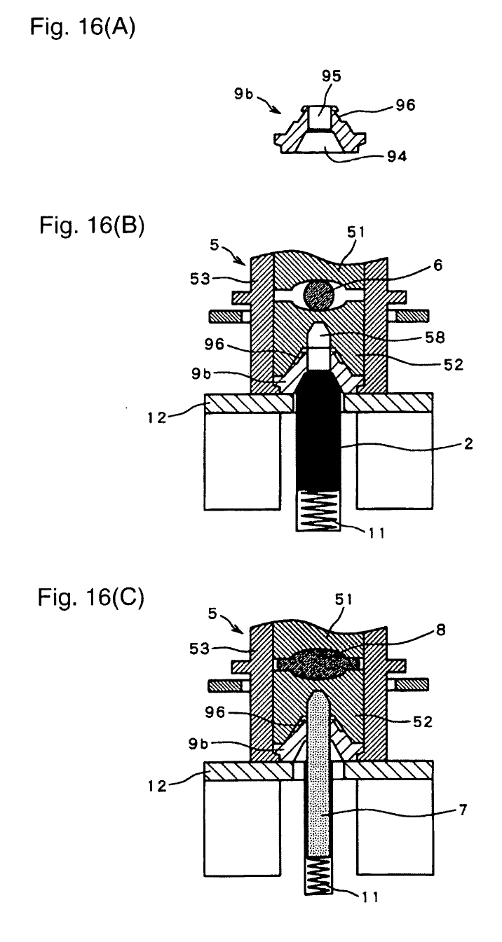

FIG. 16 is a vertical cross-sectional view showing a different embodiment of the present invention, wherein heat transfer pieces 9b and a mold 5 are configured as a single unit.

FIG. 16(A) shows a heat transfer piece 9b, which has through holes 94 and 95 formed in a central portion thereof so as to receive the leading end of a heat source for heating 2 or a heat source for cooling 7. The heat transfer piece has a notched portion 96 formed in a portion of the outer peripheral surface thereof. The notched portion 96 serves as a non-contact portion between the mold 5 and the heat transfer piece 9b. By modifying the size or the position of the non-contact portion, it is possible to adjust the contact surface between the heat transfer 9b and the mold 5, and the temperature distribution given to the mold.

FIG. 16(B) shows a heating operation. A heat source for heating 2 is inserted into a lower through hole 94 of the heat transfer piece 9b from under a mold stage 12 for the mold 5, carrying out heating. Thus, the mold 5 is heated through the lateral surface of the heat transfer piece 9b.

FIG. 16(C) shows a cooling operation. A heat source for cooling 7 is put into the heat transfer piece 9b from under the mold stage 12, is passed through the lower through hole 94 and the upper through hole 95 of the heat transfer piece 9b and is inserted into a concave portion 58 formed in a bottom mold 52. Thus, the heat source for cooling 7 is brought into contact with a position extremely close to a molded product 8 in the mold 5, so that the molded product 8 is intensively cooled at a central portion thereof. Furthermore, the entire mold 5 is slowly cooled through the lateral surface of the heat transfer piece 9b, with the result that an end portion of the mold product 8 is cooled accordingly.

In order that leading edges of the heat source for heating 2 and the heat source for cooling 7 can be correctly engaged at a certain position even when a difference in dimension is caused because of the mold 5 and the heat transfer 9b having different coefficient of thermal expansion, a spring 11 is disposed on the side of these heat sources.

By forming each of the heat transfer pieces 9b as an integral part of the mold 5 and forming the through holes in such a central portion of each of the heat transfer pieces to carry out the heating or cooling step, it is easily possible to heat the material 6 from a peripheral portion thereof in the heating operation and to intensively cool a central portion of the molded product 8 in the cooling operation. By modifying the shape of the heat transfer pieces, it is possible to carry out the heating and cooling operations in an opposite way.

In the case shown in FIG. 16(C), the heat sources for cooling 7 per se along with the heat transfer pieces 9b form the heat transfer member since the heat sources for cooling 7 are brought into direct contact with the mold.

### INDUSTRIAL APPLICABILITY

The present invention is applicable to a molding process for molding a product, which comprises heating, molding and cooling steps.

The entire disclosure of Japanese Patent Application No. 2005-328579 filed on Nov. 14, 2005 including specification, claims, drawings and summary is incorporated herein by reference in its entirety.

What is claimed is:

1. A method for molding an optical element, comprises subjecting a mold to a heating step, a press-molding step and a cooling step, the mold comprising a top mold, a bottom mold and a body mold;
further comprising bringing the mold in contact with a heat transfer member to heat or cool the mold in at least one of the heating step, the press-molding step and the cooling step, the heat transfer member having a substantially symmetrical temperature distribution.

2. The method according to claim 1, wherein the temperature distribution is axisymmetrical with respect to a central axis, and wherein the central axis substantially conforms to the optical axis of the optical element to be molded by the mold.

3. The method according to claim 1, wherein the temperature distribution is point-symmetrical with respect to a central point, and wherein the central point substantially conforms to a point on the optical axis of the optical element to be molded by the mold.

4. The method according to claim 1, wherein the temperature distribution is line-symmetrical with respect to a central line, and wherein the central line substantially conforms to the central line of the optical element to be molded by the mold.

5. The method according to claim 1, wherein the temperature distribution is plane-symmetrical with respect to a central plane, and wherein the central plane substantially conforms to a central plane of the optical element to be molded by the mold.

6. The method according to claim 1, wherein the mold and the heat transfer member are configured so that one of a convex portion and a concave portion engageable with the convex portion, which are formed as an engageable portion, is formed in the mold, the other is formed in the heat transfer member, and the mold and the heat transfer member are coupled together through the engageable portion, and wherein at least one of the convex portion and the concave portion of the engageable portion has a tapered guide surface formed thereon, whereby the engageable portion is put into engagement along the guide surface to perform positioning.

7. The method according to claim 6, wherein the convex portion and the concave portion have tapered guide surfaces formed thereon so as to have the same inclination as each other, and wherein the guide surfaces are engaged together, being brought into surface contact with each other.

8. A molding apparatus for carrying out the method for molding an optical element, defined in claim 1, comprising a heat source for heating or cooling a mold, whereby the mold is provided with a substantially symmetrical temperature distribution by heat applied from the heat source.

9. The molding apparatus according to claim 8, further comprising a heat transfer member, the heat transfer member transferring heat from the heat source to the mold.

10. The molding apparatus according to claim 9, wherein the heat source per se forms the heat transfer member.

11. The molding apparatus according to claim 9, wherein the heat transfer member comprises a mold stage, and wherein one of the mold and the mold stage has a convex portion formed integrally therewith, and the other has a concave portion formed therein so as to be engageable with the convex portion.

12. The molding apparatus according to claim 9, wherein the heat transfer member comprises a heat transfer piece, which is interposed between the heat source and the mold stage and is separate from the heat source and the mold stage, and wherein the mold and the heat transfer piece are coupled together, being aligned with each other.

13. The molding apparatus according to claim 11, wherein the heat transfer member has a through hole formed in a central portion thereof so as to insert the heat source.

14. The molding apparatus according to claim 12, wherein the heat transfer member has a through hole formed in a central portion thereof so as to insert the heat source.
